(19) United States
(12) Patent Application Publication
(10) Pub. No.: US 2014/0379446 A1
(43) Pub. Date: Dec. 25, 2014

(54) INFORMATION MANAGEMENT DEVICE, INFORMATION MANAGEMENT SYSTEM, INFORMATION MANAGEMENT METHOD, AND RECORDING MEDIUM

(71) Applicant: YAHOO JAPAN CORPORATION, Tokyo (JP)

(72) Inventor: Yasuyoshi ABE, Tokyo (JP)

(73) Assignee: YAHOO JAPAN CORPORATION, Tokyo (JP)

(21) Appl. No.: 13/958,225

(22) Filed: Aug. 2, 2013

(30) Foreign Application Priority Data
Jun. 19, 2013 (JP) 2013-129055

(51) Int. Cl. G06Q 30/02

(52) U.S. Cl. CPC G06Q 30/0214; G06Q 30/0246
USPC 705/14.16; 705/14.45

(57) ABSTRACT

An information management device includes a storage unit that stores distribution information representing whether shop information has been distributed. The information management device includes a determining unit that determines whether the shop information has been distributed when a request for distributing of the shop information from a first user to a second user is received. The information management device includes a distributing unit that distributes the shop information to the second user when the determining unit determines that the shop information has not been distributed. The information management device includes an updating unit that updates the distribution information to distribution information representing that the shop information has been distributed when the distributing unit distributes the shop information to the second user, and updates the distribution information to distribution information representing that the shop information has not been distributed when the second user uses a store related to the shop information.

### CROSS-REFERENCE TO RELATED APPLICATIONS

The present application claims priority to and incorporates by reference the entire contents of Japanese Patent Application No. 2013-129055 filed in Japan on Jun. 19, 2013.

### BACKGROUND OF THE INVENTION

1. Field of the Invention

The present invention relates to an information management device, an information management system, an information management method, and an information management program.

2. Description of the Related Art

In the past, information introduction systems in which an existing customer introduces a store or distributes a coupon to a new customer who is expected to visit a store in order to increase the number of customers of a store have been known. As an example of the information introduction system, known is an information introduction system in which an existing customer distributes a coupon to a new customer, and when the distributed coupon is used, a reward such as a point is delivered to the existing customer.

For example (see Patent Document 1: Japanese Laid-open Patent Publication No. 2006-277716 and Patent Document 2: Japanese Laid-open Patent Publication No. 2007-079977), the existing customer notifies a center device of a store to be introduced to the new customer and a mail address of the new customer using a terminal device. In this case, the center device transmits a store introduction mail including a coupon, an address of the notified store, and the like to a terminal device represented by the notified mail address. Further, when the fact that the new customer has used the store is confirmed through a near field communication between a store device and a terminal device of the new customer, the center device delivers a reward such as a point to the existing customer who has introduced the store to the new customer.

However, in the conventional techniques, distribution of a coupon by the existing customer is left to the existing customer's discretion. For this reason, the existing customer may distribute a coupon to a large indefinite number of new customers in order to easily get a reward. In this case, it is difficult to cause efficiently new customers to come to a store, and it is difficult to generate a customer luring cycle encouraging new customers to come to a store by distribution of a coupon. Further, since it is difficult to predict how many coupons are used among distributed coupons, it is difficult to adjust a value of a coupon added by a store.

### SUMMARY OF THE INVENTION

It is an object of the present invention to at least partially solve the problems in the conventional technology.

According to one aspect of an embodiment of the present invention, an information management device includes a storage unit that stores distribution information representing whether shop information has been distributed. The information management device includes a determining unit that determines whether the shop information has been distributed with reference to the distribution information stored in the storage unit when a distribution request for requesting distribution of the shop information from a first user to a second user is received. The information management device includes a distributing unit that does not distribute the shop information to the second user when the determining unit determines that the shop information has been distributed and distributes the shop information to the second user when the determining unit determines that the shop information has not been distributed. The information management device includes an updating unit that updates the distribution information to distribution information representing that the shop information has been distributed when the distributing unit distributes the shop information to the second user, and updates the distribution information to distribution information representing that the shop information has not been distributed when the second user uses a store related to the shop information.

According to another aspect of an embodiment of the present invention, an information management system includes a plurality of terminal devices. The information management system includes a message delivery device that relays a message. The information management system includes an information management device that manages shop information. The message delivery device includes a first determining unit that determines whether distribution instruction of shop information is included in the message to be transmitted from a first terminal device to a second terminal device. The message delivery device includes a transmitting unit that transmits a distribution request for requesting distribution of the shop information from the first terminal device to the second terminal device to the information management device when the first determining unit determines that the distribution instruction of the shop information is included in the message. The information management device includes a storage unit that stores distribution information representing whether the shop information has been distributed. The information management device includes a second determining unit that determines whether the shop information related to the distribution request has been distributed with reference to the distribution information stored in the storage unit when the distribution request is received from the message delivery device. The information management device includes a distributing unit that does not distribute the shop information to the second terminal device when the second determining unit determines that the shop information related to the distribution request has been distributed and distributes the shop information to the second terminal device when the second determining unit determines that the shop information has not been distributed. The information management device includes an updating unit that updates the distribution information to distribution information representing that the shop information has been distributed when the distributing unit distributes the shop information to the second terminal device, and updates the distribution information to distribution information representing that the shop information has not been distributed when a user of the second terminal device uses a store related to the shop information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory diagram illustrating exemplary functions provided by an information management system according to an embodiment;

FIG. 2 is a diagram for describing the exemplary information management system according to an embodiment;

FIG. 3 is a diagram for describing an exemplary functional configuration of a message delivery server according to an embodiment;

FIG. 4 is a diagram for describing an exemplary functional configuration of an information management device according to an embodiment;

FIG. 5 is a diagram for describing an example of information stored in a coupon management table according to an embodiment;

FIG. 6 is a diagram for describing an example of information stored in a use management table according to an embodiment;

FIG. 7 is a diagram for describing an exemplary operation performed by a customer of an introduction source;

FIG. 8 is a diagram for describing an exemplary operation performed by a customer of an introduction destination;

FIG. 9 is a diagram for describing an exemplary customer luring cycle generated by the information management system according to an embodiment;

FIG. 10 is a flowchart for describing a flow of a process performed when the information management device according to an embodiment receives a coupon distribution request;

FIG. 11 is a flowchart for describing a flow of a process performed when the information management device according to an embodiment receives a coupon use notification;

FIG. 12 is a flowchart for describing a flow of a reward provision process performed by the information management device according to an embodiment; and

FIG. 13 is a diagram illustrating an exemplary hardware configuration of a computer that executes the information management program.

### DETAILED DESCRIPTION OF THE PREFERRED EMBODIMENTS

Hereinafter, modes (hereinafter, referred to “embodiments”) for carrying out an information management device, an information management system, an information management method, and an information management program according to the present disclosure will be described in detail with reference to the appended drawings. Further, the information management device, the information management system, an information management method, and the information management program according to the present disclosure are not limited to the following embodiments. In the following embodiments, structural elements that have substantially the same function and structure are denoted with the same reference numerals, and repeated explanation of these structural elements will not be made.

### 1. Information Management System

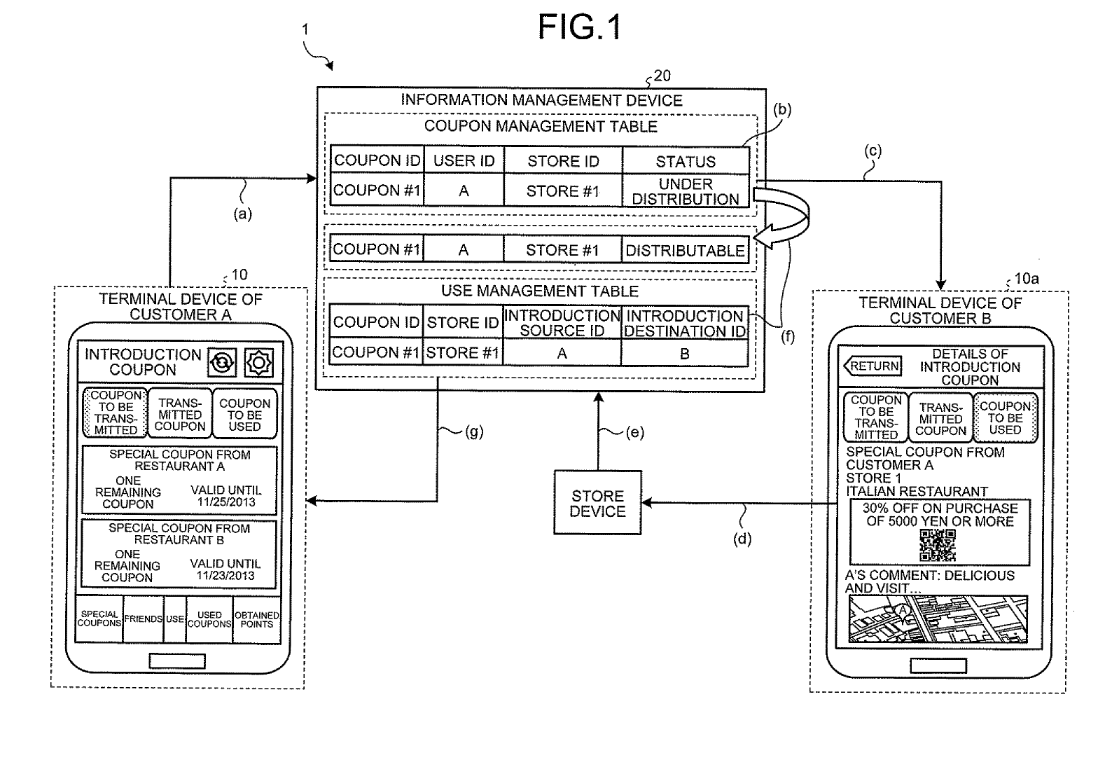

First of all, an example of a process performed by the information management system according to the embodiment will be described with reference to FIG. 1. FIG. 1 is an explanatory diagram illustrating exemplary functions provided by the information management system according to the embodiment. In the example illustrated in FIG. 1, an information management system 1 includes a terminal device 10 of a customer A who uses the information management system 1, an information management device 20, and a terminal device 10a of a customer B who uses the information management system.

The information management device 20 includes a coupon management table in which a coupon ID representing a coupon distributed from the terminal device 10 to the terminal device 10a, a user ID representing a customer serving as a coupon distribution source, a store ID representing a store related to a coupon, and a status representing whether a coupon has been distributed are associated with one another. The information management device 20 further includes a use management table in which the coupon ID, the store ID, an introduction source ID representing a customer serving as a coupon distribution source, and an introduction destination ID representing a customer serving as a coupon distribution destination are associated with one another.

First of all, in the information management system 1 illustrated in FIG. 1, the customer A of the terminal device 10 selects a coupon whose coupon ID is “coupon #1”, for example, a special coupon from an A restaurant as a coupon to be transmitted to the customer B of the terminal device 10a. In this case, the terminal device 10 notifies the information management device 20 of the coupon ID “coupon #1” of the selected coupon and a mail address of the terminal device 10a serving as the coupon distribution destination ((a) in FIG. 1).

In this case, the information management device 20 checks a status associated with a set of the coupon ID “coupon #1” of the notified coupon and the user ID “A” of the customer A, and updates the status to “under distribution” when the checked status is “distributable” ((b) in FIG. 1). Then, the information management device 20 transmits a uniform resource locator (URL) for acquiring the selected coupon of the “A restaurant”, that is, the coupon whose coupon ID is “coupon #1” to the terminal device 10a of the customer B ((c) in FIG. 1).

Here, the customer B downloads the coupon of the “A restaurant” to the terminal device 10a using the URL transmitted to the terminal device 10a. Then, the customer B uses the coupon when using the “A restaurant” ((d) in FIG. 1). In this case, the information management device 20 receives a coupon use notification from a store device of the “A restaurant” ((e) in FIG. 1). Then, the information management device 20 updates a status associated with the coupon ID “coupon #1” of the used coupon and the user ID “A” of the customer A serving as a coupon introduction source to “distributable” with reference to the coupon management table ((f) in FIG. 1).

Further, the information management device 20 stores the coupon ID “coupon #1” of the used coupon, a store ID “store #1” representing a store in which the coupon has been used, the user ID “A” of the customer A serving as the coupon introduction source, and the user ID “B” of the customer B serving as the coupon introduction destination in the use management table in association with one another. Thereafter, the information management device 20 gives a reward such as a point to the customer A represented by the introduction source ID stored in the use management table ((g) in FIG. 1).

Here, the information management device 20 suspends distribution of the same coupon from the customer A to another customer C until the customer B uses the store after the customer A distributes the coupon to the customer B. In other words, when the status associated with a set of the coupon ID “coupon #1” notified from the terminal device 10 and the user ID “A” of the customer A is “under distribution”, the URL of the coupon is not transmitted to the terminal device 10a, and notification of an error is given to the terminal device 10.

As described above, the information management device 20 does not allow the customer A to distribute the same coupon to another customer C or the like until the customer B uses the distributed coupon after the customer A distributes the coupon to the customer B. Thus, the information management device 20 can induce the customer A to distribute a coupon to a customer who is likely to use the coupon. As a result, the information management device 20 can encourage a new customer to come to a store through distribution of a coupon.

Further, the information management device 20 allows redistribution of the used coupon from the customer A to another customer again when the coupon distributed from the customer A to the customer B is used. Thus, the information management device 20 can generate the customer luring cycle encouraging a new customer to come to a store through distribution of a coupon.

In addition, when the customer A is allowed to distribute a plurality of pieces of same coupons, the information management device 20 generates entries, each of which includes a set of the same coupon ID, the user ID, and the store ID, as many as the pieces of coupons set to “distributable” in the coupon management table. The information management device 20 may update the statuses of the generated entries to “under distribution” one by one when the customer A distributes the coupons and suspend distribution of the same coupon by the customer A when the statuses of all entries are updated to “under distribution”. When this process is executed, the information management device 20 can induce the coupons to be distributed to customers who are likely to use the coupons even when a plurality of pieces of coupons are distributed.

FIG. 1 has been described in connection with the example in which the information management device 20 distributes a coupon using a mail or a URL. However, an embodiment is not limited to this example. For example, the information management device 20 may distribute a coupon through a messenger application such as Kakao Talk (a registered trademark).

### 2. System Configuration of Information Management System

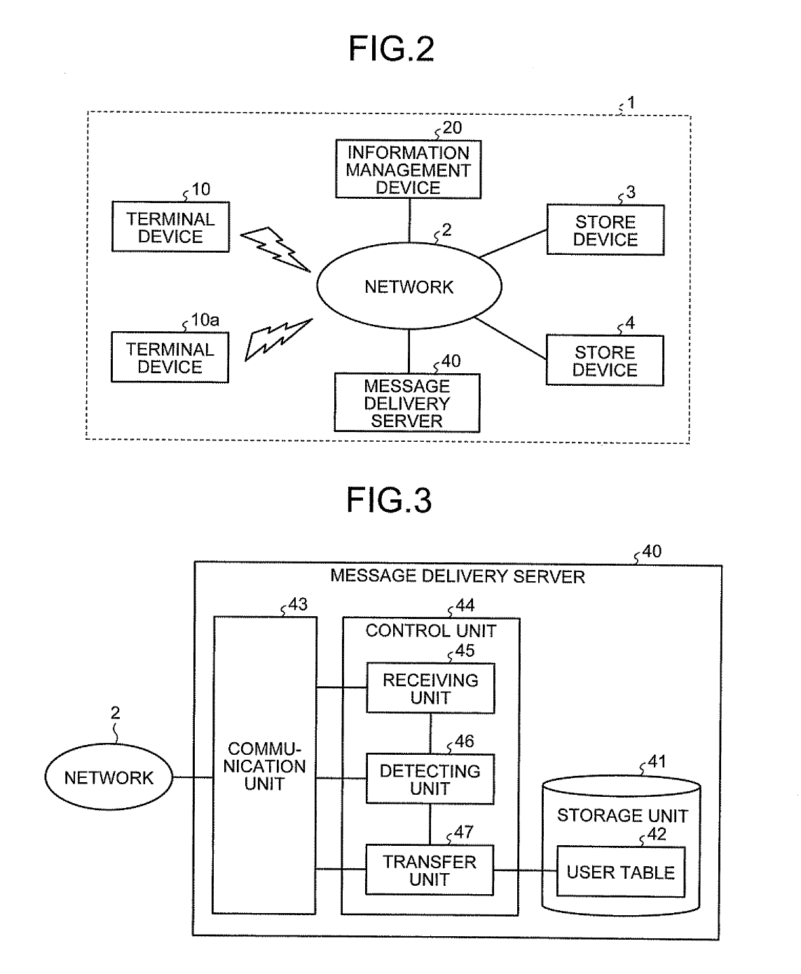

Next, a system configuration of the information management system 1 according to an embodiment will be described with reference to FIG. 2. FIG. 2 is a diagram for describing an exemplary information management system according to an embodiment. The information management system 1 includes a network 2, store devices 3 and 4, a plurality of terminal devices 10 and 10a, an information management device 20, and a message delivery server 40 as illustrated in FIG. 2.

The store devices 3 and 4, the information management device 20, and the message delivery server 40 are connected to one another via the arbitrary network 2 such as a local area network (LAN), a wide area network (WAN), or the Internet. The terminal devices 10 and 10a are connected to the network 2 through a wired communication scheme such as a LAN or a WAN or a wireless communication scheme such as 3rd generation (3G), Long Term Evolution (LTE), Wi-Fi (a registered trademark), or a wireless LAN.

The following description will proceed with an example in which a coupon is distributed from the customer A who is the user of the terminal device 10 to the customer B who is the user of the terminal device 10a, but an embodiment is not limited to this example. In other words, the terminal devices 10 and 10a are assumed to be terminal devices capable of performing the same function.

The store devices 3 and 4 are devices installed at stores used by the owners of the terminal devices 10 and 10a, and information processing devices capable of performing communication with the terminal devices 10 and 10a through an arbitrary wired communication scheme or wireless communication scheme. For example, the store devices 3 and 4 perform communication with the terminal devices 10 and 10a through a non-contact type communication scheme such as Bluetooth (a registered trademark) or Felica (a registered trademark).

Here, when a coupon downloaded to each of the terminal devices 10 and 10a is read, each of the store devices 3 and 4 transmits a use notification representing the fact that the coupon has been used to the information management device 20 via the network 2. Specifically, each of the store devices 3 and 4 acquires a coupon ID of a used coupon, an introduction source ID representing a customer serving as a coupon introduction source, and an introduction destination ID representing a customer who has used a coupon, that is, a customer serving as a coupon introduction destination. Then, each of the store devices 3 and 4 generates a use notification including the store ID representing a store, the acquired coupon ID, the introduction source ID, and the introduction destination ID, and transmits the generated use notification to the information management device 20 via the network 2.

The terminal devices 10 and 10a are terminal devices used by the customers of the information management system 1. For example, the terminal devices 10 and 10a are terminal devices having a function of performing wireless communication such as 3G or LTE and a function of performing non-contact type communication such as Felica (a registered trademark). Further, the terminal devices 10 and 10a access the information management device 20 via the network 2, and have a function of distributing and acquiring a coupon. For example, the terminal devices 10 and 10a transmit a coupon through a mail or a messenger application such as Kakao Talk (a registered trademark).

Next, an example of a process performed by the terminal devices 10 and 10a when a coupon is distributed will be described. For example, the terminal device 10 accesses the information management device 20 using a function of an Internet browser or application, and acquires a list of coupons distributable by the user of the terminal device 10, for example, the customer A. Then, when the customer A selects a coupon of a distribution target from the list of the coupons, the terminal device 10 displays a selection screen through which either a mail or a messenger application is selected to transmit a coupon. Then, when the customer A selects mail transmission, the terminal device 10 displays a message input screen, and encourages the customer A to input an introductory essay for a store related to a coupon.

Then, when the customer A inputs the introductory essay, the terminal device 10 urges the customer A to input a mail address of the customer B serving as the coupon distribution destination. Then, the terminal device 10 transmits a distribution request including the user ID of the customer A, that is, the introduction source ID representing the coupon introduction source, the coupon ID of the coupon selected by the customer A, and a mail address of the customer B to the information management device 20.

In this case, the terminal device 10a receives a mail including a URL representing a download page of a coupon and the introductory essay of the customer A from the information management device 20. Then, when access to the acquired URL is made, the terminal device 10a downloads information of the coupon including the coupon ID. Thereafter, the terminal device 10a transmits the coupon ID to the store devices 3 and 4 through non-contact type communication, and then uses a coupon.

Meanwhile, when the customer A selects the messenger application, the terminal device 10 encourages selection of the customer B serving as the coupon distribution destination on the messenger application. Further, the terminal device 10 may receive input of an ID assigned to the customer B on the messenger application, that is, an ID used to transmit a message to the terminal device 10a of the customer B. Then, the terminal device 10 urges the customer A to input an introductory essay, and when the customer A inputs the introductory essay, the terminal device 10 generates a message including the coupon ID and the introductory essay, and transmits the generated message whose transmission destination is set to the customer B to the message delivery server 40.

The information management device 20 stores a status representing the fact that the coupon distributed by the customer A who is the user of the terminal device 10 has been distributed or a status representing that the coupon is distributable together with the coupon ID. Further, when the distribution request including the coupon ID is received, the information management device 20 extracts the coupon ID from the distribution request, and refers to the status associated with the extracted coupon ID. Then, when the referred status represents “distributable”, the information management device 20 distributes the coupon. However, when the referred status represents “distributed”, the information management device 20 does not distribute the coupon.

For example, when the distribution request is received from the terminal device 10, the information management device 20 extracts the user ID of the customer A who is the user of the terminal device 10, that is, the introduction source ID, the coupon ID from the distribution request, the mail address serving as the coupon distribution destination, and the introductory essay. Further, the information management device 20 refers to the status associated with a set of the extracted coupon ID and the user ID using the introduction source ID as the user ID. Then, when the referred status represents “distributable”, the information management device 20 generates a web page used to download the coupon represented by the coupon ID, and generates a mail including a URL of the generated web page and the extracted introductory essay. Thereafter, the information management device 20 transmits the generated mail using the extracted mail address as the destination.

However, when the status associated with the extracted coupon ID represents “distributed”, the information management device 20 transmits a notification representing the coupon has been distributed to the terminal device 10. As a result, the terminal device 10 displays the fact that distribution of the coupon is not performed, and encourages the user to distribute another coupon.

Further, when the distribution request is received from the message delivery server 40, the information management device 20 extracts the coupon ID and the introduction source ID from the received distribution request, and refers to the status associated with a set of the extracted coupon ID and the user ID using the extracted introduction source ID as the user ID. Then, when the referred status represents “distributable”, the information management device 20 transmits the coupon represented by the coupon ID to the message delivery server 40. However, when the status associated with the set of the extracted coupon ID and the user ID represents “distributed”, the information management device 20 transmits a notification representing the fact that the coupon has been distributed to the message delivery server 40.

Further, when the use notification is received, the information management device 20 extracts the coupon ID and the introduction source ID from the use notification, and searches for the status representing that the coupon has been distributed among statuses associated with the set of the extracted coupon ID and the user ID using the introduction source ID as the user ID. Then, the information management device 20 updates the searched status to a status representing “distributable”. Further, the information management device 20 extracts the store ID, the coupon ID, the introduction source ID, and the introduction destination ID from the use notification, and stores the extracted IDs in the use management table in association with one another.

Thereafter, the information management device 20 decides to give a reward such as a point to the customer represented by the introduction source ID with reference to the use management table at an arbitrary timing, for example, at predetermined time intervals. Then, the information management device 20 transmits the reward to the customer represented by the introduction source ID.

When the message including the coupon ID is received from the terminal device 10, the message delivery server 40 extracts the coupon ID from the received message. Further, the message delivery server 40 identifies the user ID representing the user of the transmission source of the message, that is, the introduction source ID. Then, the message delivery server 40 transmits the distribution request including the introduction source ID and the coupon ID to the information management device 20. Further, when the coupon is received from the information management device 20, the message delivery server 40 adds the coupon to the received message, and transmits the resultant message to the terminal device 10a.

As a result, the terminal device 10a displays the coupon through the messenger application and stores the coupon ID included in the message. Meanwhile, when a notification representing that the coupon has been distributed is received from the information management device 20, the message delivery server 40 transmits the notification representing the coupon has been distributed to the terminal device 10.

### 3. Functional Configuration of Message Delivery Server

Next, an exemplary functional configuration of the message delivery server 40 will be described with reference to FIG. 3. FIG. 3 is a diagram for describing an exemplary functional configuration of the message delivery server according to an embodiment. In the example illustrated in FIG. 3, the message delivery server 40 includes a storage unit 41, a communication unit 43, and a control unit 44. The storage unit 41 includes a user table 42. Here, the user table 42 is a table in which an ID representing the customer of the messenger application is associated with a terminal device used by a customer represented by an ID. The control unit 44 includes a receiving unit 45, a detecting unit 46, and a transfer unit 47.

The communication unit 43 controls data communication between the message delivery server 40 and either of the terminal devices 10 and 10a or the information management device 20. Specifically, the communication unit 43 controls transmission and reception of a message, a coupon, a notification representing the fact that a coupon has been distributed, and the distribution request. For example, when a message is received via the network 2, the communication unit 43 outputs the received message to the receiving unit 45.

Further, when a message is received from the transfer unit 47, the communication unit 43 transmits a message to a terminal device of a message transmission destination via the network 2. Further, when a coupon or a notification representing the fact that a coupon has been distributed is received, the communication unit 43 outputs the received coupon or the notification representing the fact that the coupon has been distributed to the detecting unit 46 via the network 2. Further, when the distribution request is received from the detecting unit 46, the communication unit 43 transmits the received distribution request to the information management device 20.

The receiving unit 45 receives a message of the messenger application. For example, when the message is received from the communication unit 43, the receiving unit 45 outputs the received message to the detecting unit 46.

The detecting unit 46 detects the coupon ID from the message. For example, when the message is received from the receiving unit 45, the detecting unit 46 determines whether the coupon ID is included in the received message. Then, when the coupon ID is not included in the received message, the detecting unit 46 outputs the received message to the transfer unit 47.

However, when the coupon ID is included in the received message, the detecting unit 46 extracts the user ID of the message transmission source, that is, the introduction source ID and the coupon ID, and generates the distribution request including the extracted coupon ID and the introduction source ID. Then, the detecting unit 46 outputs the generated distribution request to the communication unit 43. Here, when the coupon is received from the communication unit 43 as a result of outputting the distribution request to the communication unit 43, the detecting unit 46 stores the coupon received from the communication unit 43 in the message received from the receiving unit 45, and outputs the received coupon to the transfer unit 47.

Meanwhile, when the notification representing the fact that the coupon has been distributed is received, as a result of outputting the distribution request to the communication unit 43, the detecting unit 46 generates a message including the fact that the coupon has been distributed. Further, the detecting unit 46 extracts an ID of a transmission source from the message received from the receiving unit 45, and sets the extracted ID as a destination of the generated message. Then, the detecting unit 46 outputs the generated message to the transfer unit 47.

The transfer unit 47 performs a process of transferring the message. For example, when the message is received from the detecting unit 46, the transfer unit 47 extracts the user ID of the destination from the received message, and searches for a terminal device associated with the extracted user ID from the user table 42. Then, the transfer unit 47 sets the searched terminal device as the destination of the received message, and outputs the message to the communication unit 43.

### 4. Functional Configuration of Information Management Device

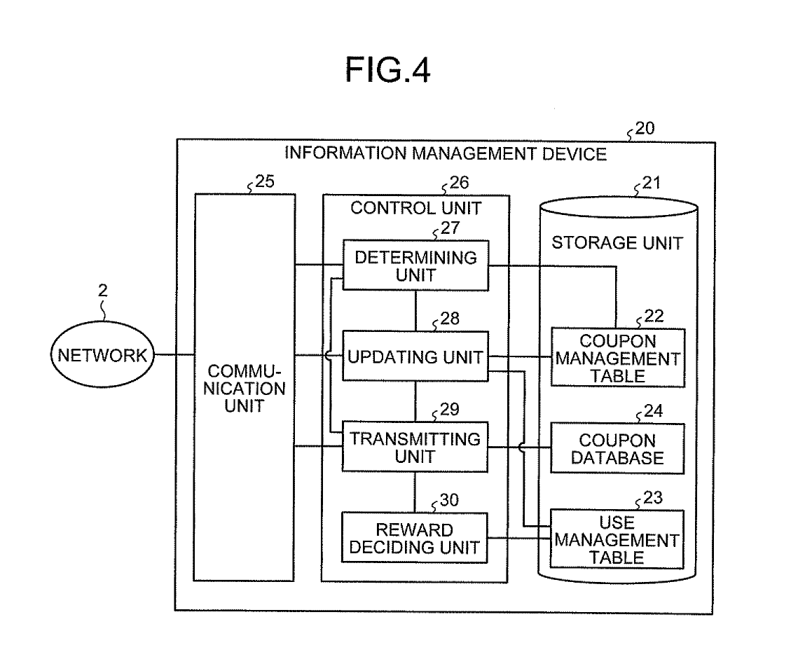

Next, a functional configuration of the information management device 20 will be described with reference to FIG. 4. FIG. 4 is a diagram for describing an exemplary functional configuration of the information management device according to an embodiment. In the example illustrated in FIG. 4, the information management device 20 includes a storage unit 21, a communication unit 25, and a control unit 26. The storage unit 21 includes a coupon management table 22, a use management table 23, and a coupon database 24. The control unit 26 includes a determining unit 27, an updating unit 28, a transmitting unit 29, and a reward deciding unit 30.

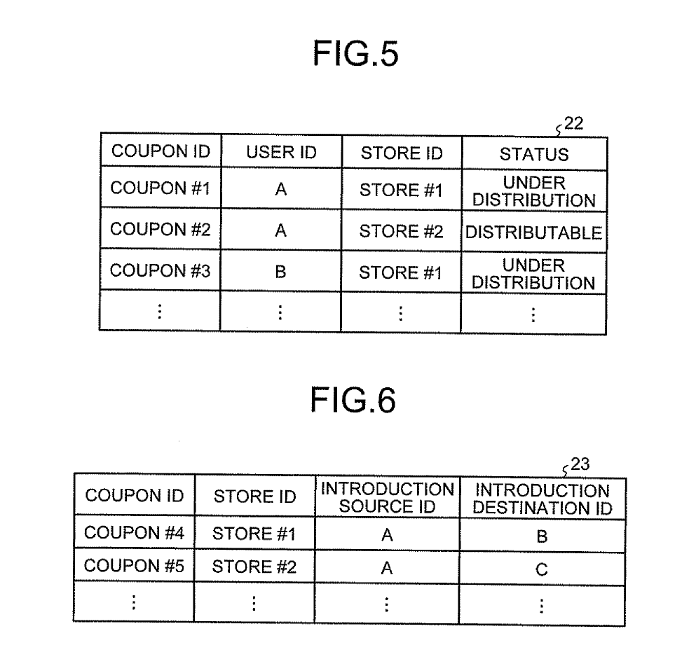

The coupon management table 22 is a table in which a status representing whether the coupon has been distributed is stored in association with the coupon ID. For example, FIG. 5 is a diagram for describing an example of information stored in the coupon management table according to an embodiment. The coupon management table 22 stores the coupon ID, the user ID, the store ID, and the status in association with one another as illustrated in FIG. 5.

For example, in the example illustrated in FIG. 5, a coupon ID “coupon #1”, a user ID “A”, a store ID “store #1”, and a status “under distribution” are stored in a first entry of the coupon management table 22 in association with one another. Thus, the coupon management table 22 represents that among coupons of a store represented by the store ID “store #1”, a coupon represented by the coupon ID “coupon #1” has been already distributed by the customer A represented by the user ID “A”.

For example, a coupon ID “coupon #2”, a user ID “A”, a store ID “store #2”, and a status “distributable” are stored in a second entry of the coupon management table 22 in association with one another. Thus, the coupon management table 22 represents that among coupons of a store represented by the store ID “store #2”, a coupon represented by the coupon ID “coupon #2” is distributable by the customer A. Further, a coupon ID “coupon #3”, a user ID “B”, a store ID “store #1”, and a status “under distribution” are stored in a third entry of the coupon management table 22 in association with one another. Thus, the coupon management table 22 represents that among coupons of the store represented by the store ID “store #1”, a coupon represented by the coupon ID “coupon #3” has been distributed by the customer B.

The coupon management table 22 is assumed to include an entry in which the coupon ID, the user ID, the store ID, and the status are associated with one another in addition to the entries illustrated in FIG. 5. Further, when a plurality of coupons having the same content are distributable, the coupon management table 22 includes a plurality of entries which are the same in a set of the coupon ID, the user ID, and the store ID. For example, when three coupons represented by the coupon ID “coupon #1” are distributable by the customer A, the coupon management table 22 includes three entries each of which stores the coupon ID “coupon #1”, the user ID “A”, and the store ID “store #1.”

Referring back to FIG. 4, the use management table 23 stores the coupon ID of the used coupon, the coupon distribution source, and the coupon distribution destination in association with one another. For example, FIG. 6 is a diagram for describing an example of information stored in the use management table according to an embodiment. The use management table 23 stores the coupon ID, the store ID, the introduction source ID, and the introduction destination ID in association with one another as illustrated in FIG. 6.

For example, in the example illustrated in FIG. 6, a coupon ID “coupon #4”, a store ID “store #1”, an introduction source ID “A”, and an introduction destination ID “B” are stored in a first entry of the use management table 23 in association with one another. Thus, the use management table 23 represents that among coupons of the store represented by the store ID “store #1”, the coupon represented by the coupon ID “coupon #4” has been distributed from the customer A to the customer B, and the coupon distributed by the customer B has been used.

Further, a coupon ID “coupon #5”, a store ID “store #2”, an introduction source ID “A”, and an introduction destination ID “C” are stored in a second entry of the use management table 23 in association with one another. Thus, the use management table 23 represents that among coupons of the store represented by the store ID “store #2”, the coupon represented by the coupon ID “coupon #5” has been distributed from the customer A to the customer C, and the coupon distributed by the customer C has been used. The use management table 23 is assumed to include an entry in which the coupon ID, the store ID, the introduction source ID, and the introduction destination ID are associated with one another in addition to the entries illustrated in FIG. 6.

Referring back to FIG. 4, the coupon database 24 stores a coupon of a distribution target. For example, the coupon database 24 stores a coupon including a coupon use store, a store map, coupon content, a coupon period of use, a coupon ID, and the like.

The communication unit 25 controls data communication between the information management device 20 and one of the store devices 3 and 4, the terminal devices 10 and 10a, and the message delivery server 40. Specifically, when the distribution request is received from the terminal devices 10 and 10a or the message delivery server 40 via the network 2, the communication unit 25 outputs the received distribution request to the determining unit 27. Further, when a coupon or a notification representing that a coupon has been distributed is received from the transmitting unit 29, the communication unit 25 outputs the received coupon or the received notification representing that the coupon has been distributed to the terminal devices 10 and 10a or the message delivery server 40. Further, when the use notification is received from the store devices 3 and 4, the communication unit 25 outputs the received use notification to the updating unit 28.

When the distribution request is received, the determining unit 27 determines whether a coupon of a delivery target has been distributed. For example, the determining unit 27 extracts the coupon ID and the introduction source ID from the received distribution request. Then, the determining unit 27 extracts all entries including a set of the coupon ID and the user ID from the coupon management table 22 using the extracted introduction source ID as the user ID. Then, the determining unit 27 determines whether the statuses of all of the extracted entries are “under distribution”.

Here, when the status of one of the detected entries is “distributable”, the determining unit 27 outputs the received distribution request to the updating unit 28. Meanwhile, when the statuses of all of the detected entries are “under distribution”, the determining unit 27 identifies the terminal devices 10 and 10a serving as the transmission source of the distribution request or the message delivery server 40. Then, the determining unit 27 generates a notification representing that a coupon is “under distribution”, and instructs the transmitting unit 29 to transmit the generated notification to the identified transmission source.

The updating unit 28 updates the status to “under distribution” when a coupon whose status is “distributable” is distributed and updates the status to “distributable” when the distributed coupon has been used. For example, when the distribution request is received from the determining unit 27, the updating unit 28 extracts the coupon ID and the introduction source ID from the received distribution request. Then, the updating unit 28 searches for an entry whose status is “distributable” among entries including a set of the coupon ID and the user ID using the extracted introduction source. ID as the user ID. Thereafter, the updating unit 28 updates the status of the detected entry to “under distribution” and outputs the received distribution request to the transmitting unit 29.

Further, when the use notification is received from the communication unit 25, the updating unit 28 extracts the store ID, the coupon ID, the introduction source ID, and the introduction destination ID from the received use notification. Then, the updating unit 28 searches for an entry in which the extracted coupon ID and the introduction source ID are associated with each other and the status is “under distribution” from the coupon management table 22 using the extracted introduction source ID as the user ID. Further, the updating unit 28 updates the status of the searched entry from “under distribution” to “distributable”. Further, the updating unit 28 stores the extracted store ID, the coupon ID, the introduction source ID, and the introduction destination ID in the use management table 23 in association with one another.

The transmitting unit 29 distributes a coupon whose status is “distributable”. For example, when the distribution request is received from the updating unit 28, the transmitting unit 29 extracts the coupon ID from the distribution request, and acquires a coupon including the extracted coupon ID from the coupon database 24. Further, when the transmission source of the distribution request is the terminal device 10 or 10a, the transmitting unit 29 generates a web page used to download the acquired coupon. Further, the transmitting unit 29 extracts a mail address serving as a the coupon distribution destination and an introductory essay from the distribution request, and generates a mail that includes a URL of the generated web page and the introductory essay and uses the extracted mail address as a destination. Then, the transmitting unit 29 outputs the generated mail to the communication unit 25.

Meanwhile, when the transmission source of the distribution request is the message delivery server 40, the transmitting unit 29 transmits the coupon to the message delivery server 40. Further, when an instruction of transmitting a notification representing that a coupon is under distribution is received from the determining unit 27, the transmitting unit 29 outputs a notification representing that a coupon is under distribution to the communication unit 25 using the transmission source of the distribution request identified by the determining unit 27 as the destination.

When the distributed coupon has been used, the reward deciding unit 30 decides to give a reward to a customer of the coupon distribution source. For example, the reward deciding unit 30 refers to an entry stored in the use management table 23 and identifies the introduction source ID included in the referred entry. Then, the reward deciding unit 30 instructs the transmitting unit 29 to transmit a reward such as a point to the customer represented by the identified introduction source ID, and deletes the referred entry.

In this case, the transmitting unit 29 transmits a reward to the customer represented by the introduction source ID. For example, the transmitting unit 29 may transmit a point to the terminal device of the customer represented by the introduction source ID. For example, the transmitting unit 29 may access a point management system (not illustrated) and add a predetermined point to a point of the customer represented by the introduction source ID.

### 5. Exemplary Operations of Terminal Device of Customer

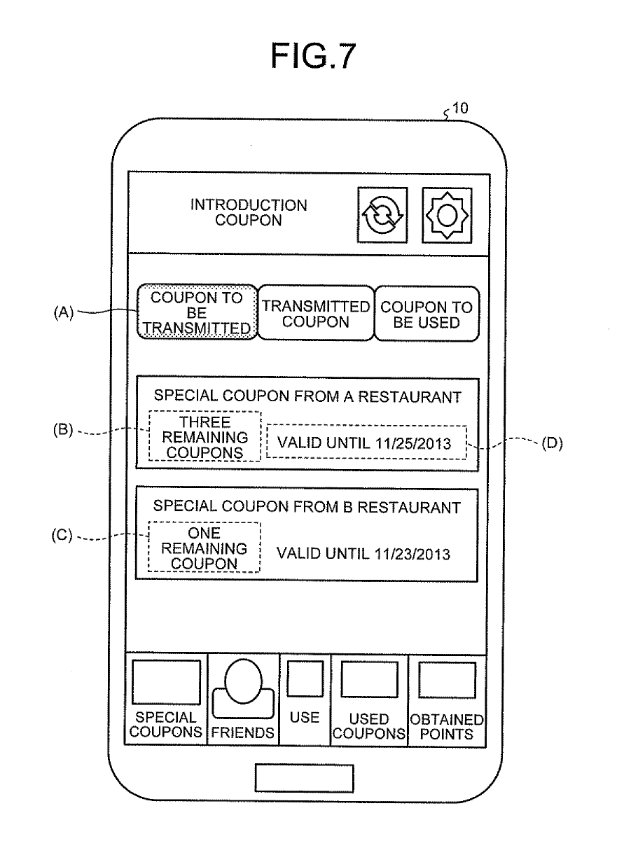

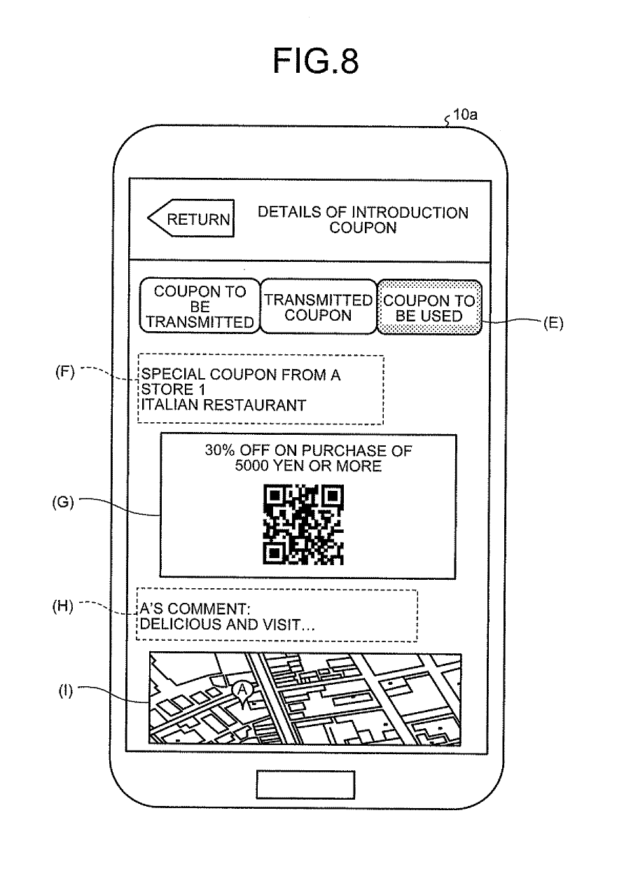

Next, exemplary operations of the terminal devices 10 and 10a when a coupon is distributed will be described with reference to FIGS. 7 and 8. Displays of the terminal devices 10 and 10a illustrated in FIGS. 7 and 8 are exemplary, and an embodiment is not limited to this example.

### 5-1. Exemplary Operation in Terminal Device of Customer of Introduction Source

Next, an exemplary operation performed when a customer of an introduction source transmits a coupon will be described with reference to FIG. 7. FIG. 7 is a diagram for describing an exemplary operation performed by a customer of an introduction source. For example, when the customer A who is the user of the terminal device 10 selects an application used to distribute or use a coupon, the terminal device 10 calls the application.

Then, when the customer A pushes a selection tab of a coupon to be transmitted to another person as illustrated in (A) of FIG. 7, the terminal device 10 accesses the information management device 20 and acquires a list of coupons which can be transmitted by the customer A. For example, when accessed by the terminal device 10, the information management device 20 notifies the terminal device 10 of content of an entry whose status is “distributable” among entries including the user ID “A” of the terminal device 10 or content of a coupon from the coupon management table 22.

Then, the terminal device 10 identifies a coupon distributable by the customer A and a distributable number of each coupon from the notified entry, and displays the identified coupon and the distributable number. For example, when there are “three” entries in which the coupon ID “coupon #1”, the store ID “A”, the user ID “A”, and the status “distributable” are stored, the terminal device 10 displays the fact that “three” “special coupons from the A restaurant” are distributable as illustrated in (B) of FIG. 7. Further, when there is “one” entry in which the coupon ID “coupon #2”, the store ID “B”, the user ID “A”, and the status “distributable” are stored, the terminal device 10 displays the fact that “one” “special coupon from the B restaurant” is distributable as illustrated in (C) of FIG. 7. Then, when any one of the coupons illustrated in FIG. 7 is pushed by the customer A, the terminal device 10 distributes the pushed coupon through the above-described process.

Further, when a coupon use period is restricted as illustrated in (D) of FIG. 7, the terminal device 10 may not display a coupon in which a period of use has expired when a coupon is distributed or used. In this case, the information management device 20 may delete an entry including the coupon ID of the coupon in which the period of use has expired from the coupon management table 22.

### 5-2. Exemplary Operation in Terminal Device of Customer of Introduction Destination

Next, an exemplary operation performed when a customer of an introduction destination uses a coupon will be described with reference to FIG. 8. FIG. 8 is diagram for describing an exemplary operation performed by a customer of an introduction destination. For example, when an application used to distribute or use a coupon is selected, the terminal device 10a calls the application, and then, a tab of a coupon to be used by the customer B is pushed as illustrated in (E) of FIG. 8, the terminal device 10a displays information of the distributed coupon.

For example, the terminal device 10a displays the customer A serving as the coupon introduction source, a store in which a coupon can be used, store information, and the like as illustrated in (F) of FIG. 8. Further, the terminal device 10a displays, for example, a QR code (a registered trademark) identifying a coupon as illustrated in (G) of FIG. 8. When it is difficult to acquire a coupon through a non-contact type communication scheme and the terminal device 10a, the store devices 3 and 4 can read the QR code (a registered trademark) displayed on the terminal device 10a through an optical reading device and check where a coupon is available. Further, the terminal device 10a displays an introductory essay from the customer A serving as the coupon introduction source as illustrated in (H) of FIG. 8. Further, the terminal device 10a displays a map of a store in which a coupon can be used as illustrated in (I) of FIG. 8.

Further, various kinds of information illustrated in FIG. 8 are exemplary information downloaded from a page of a URL received from the information management device 20 by the terminal device 10a or exemplary information that can be extracted from a message including a coupon by the terminal device 10a.

### 6. Customer Luring Cycle

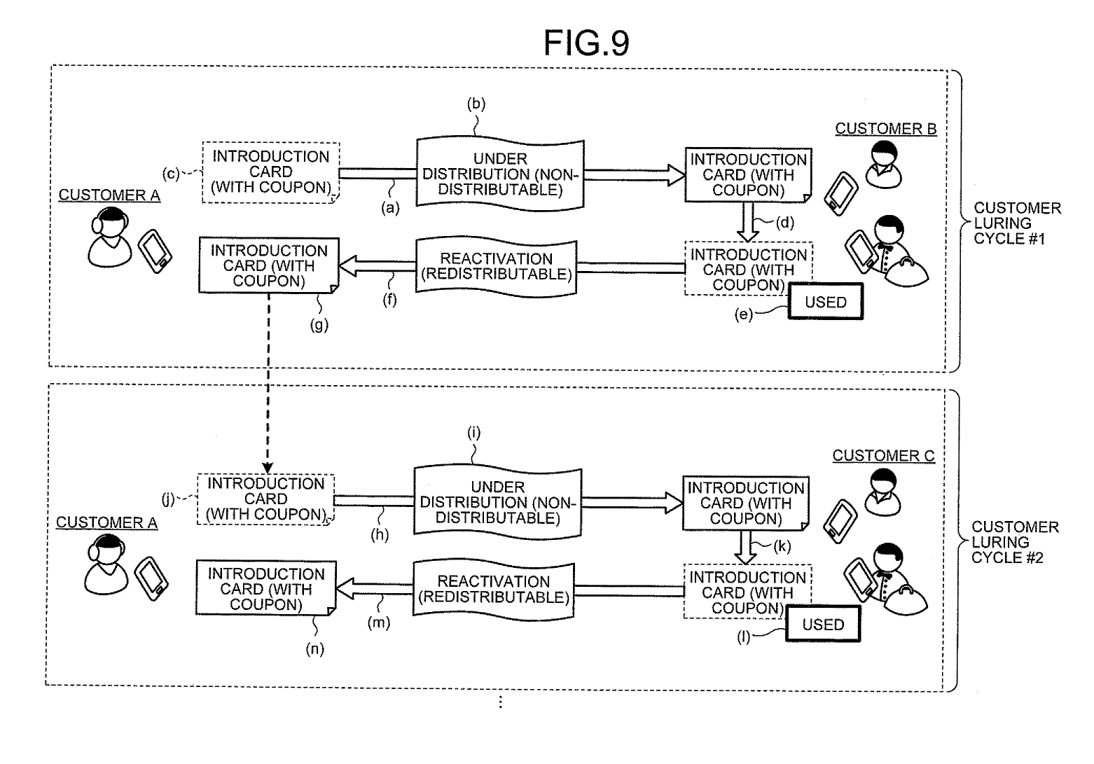

Next, an effect by which the customer luring cycle can be generated by the information management system 1 according to an embodiment will be described with reference to FIG. 9. FIG. 9 is a diagram for describing an exemplary customer luring cycle generated by the information management system according to an embodiment. FIG. 9 illustrates an example in which the customer A transmits a store introduction card including a coupon to the customer B and the customer C.

For example, the customer A introduces a store by distributing an introduction card with a coupon to the customer B as illustrated in (a) FIG. 9. In this case, the information management system 1 updates a status of the introduction card distributed by the customer A to “under distribution” as illustrated in (b) of FIG. 9. Thus, since it is difficult for the customer A to distribute the same introduction card to another customer such as the customer C, the customer A tries to distribute the introduction card to a customer who is expected to surely come to a store as illustrated in (c) of FIG. 9.

Further, when the customer B visits the store introduced by the customer A and makes a payment as illustrated in (d) of FIG. 9, the information management system 1 determines that the introduction card distributed to the customer B by the customer A has been used as illustrated in (e) of FIG. 9. Then, the information management system 1 gives a reward such as a point to the customer A as illustrated in (f) of FIG. 9. Further, the information management system 1 updates the status of the introduction card to “distributable” and reactivates the introduction card as illustrated in (g) of FIG. 9 so that the introduction card can be distributed by the customer A.

Further, the customer A distributes the reactivated introduction card to the customer C and introduces a store as illustrated in (h) of FIG. 9. Here, when the introduction card is distributed to the customer C by the customer A, since it is difficult to redistribute the introduction card until the customer C uses the introduced store, the customer A tries to distribute the introduction card to a customer who is expected to surely come to the store. In this case, the information management system 1 updates the status of the introduction card to “under distribution” as illustrated in (i) of FIG. 9 and stops distribution of the introduction card by the customer A as illustrated in (j) of FIG. 9.

Further, when the customer C visits the store and makes a payment as illustrated in (k) of FIG. 9, the information management system 1 determines that the introduction card distributed to the customer C by the customer A has been used as illustrated in (l) of FIG. 9. Then, the information management system 1 gives a reward such as a point to the customer A as illustrated in (m) of FIG. 9, and updates the status of the introduction card to “distributable” as illustrated in (n) of FIG. 9 so that the introduction card is reactivated.

As described above, when the introduction card is distributed, the information management system 1 stops redistribution of the same introduction card until a customer of a distribution destination uses a store. Thus, the information management system 1 can cause the customer A to distribute the introduction card to a customer who is more likely to come to a store. Further, when the customers B and C of the introduction destination use the store, the information management system 1 gives a reward to the customer A. Thus, the information management system 1 can motivate the customer A to repeatedly distribute the introduction card. As a result, the information management system 1 can repeatedly generate the customer luring cycle until the introduction card is used after the introduction card is distributed as illustrated in FIG. 9.

### 7. Flow of Process Performed by Information Management Device

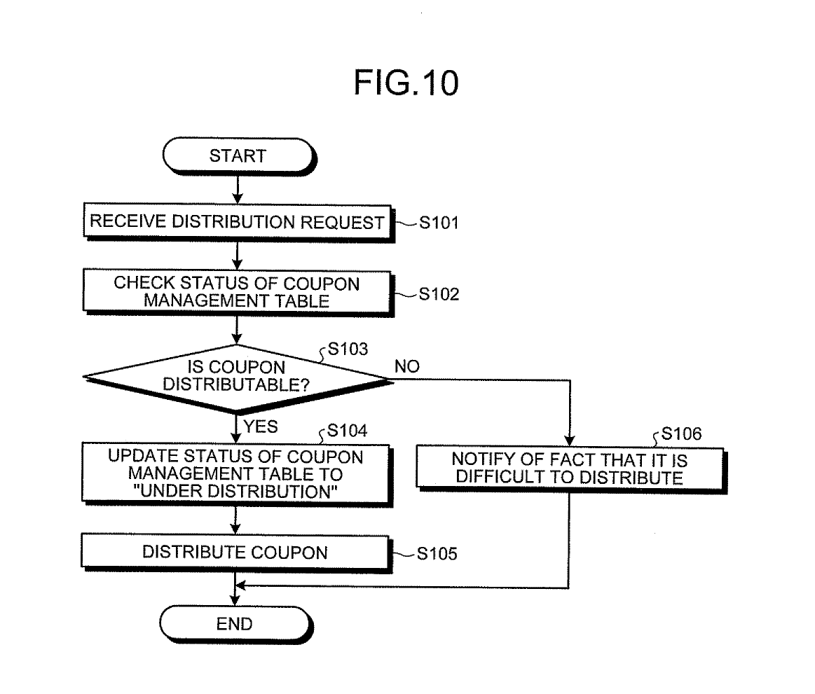

Next, the flow of a process performed by the information management device 20 will be described with reference to FIGS. 10 to 12.

### 7-1. Coupon Distribution Process

Next, the flow of a process of distributing a coupon through the information management device 20 will be described with reference to FIG. 10. FIG. 10 is a flowchart for describing the flow of a process performed when the information management device according to an embodiment receives the coupon distribution request. For example, the information management device 20 receives the distribution request (step S101). Then, the information management device 20 checks the status of the coupon of the distribution target with reference to the coupon management table 22 (step S102). Then, the information management device 20 determines whether the coupon is distributable (step S103).

Here, when it is determined that the coupon is distributable (Yes in step S103), the information management device 20 updates the status checked with reference to the coupon management table 22 to “under distribution” (step S104). Thereafter, the information management device 20 distributes the coupon to a customer of the distribution destination (step S105), and ends the process. However, when it is determined that the coupon is not distributable (No in step S103), the information management device 20 notifies the customer of the distribution source of the fact that it is difficult to distribute (step S106), and ends the process.

### 7-2. Coupon Use Check Process

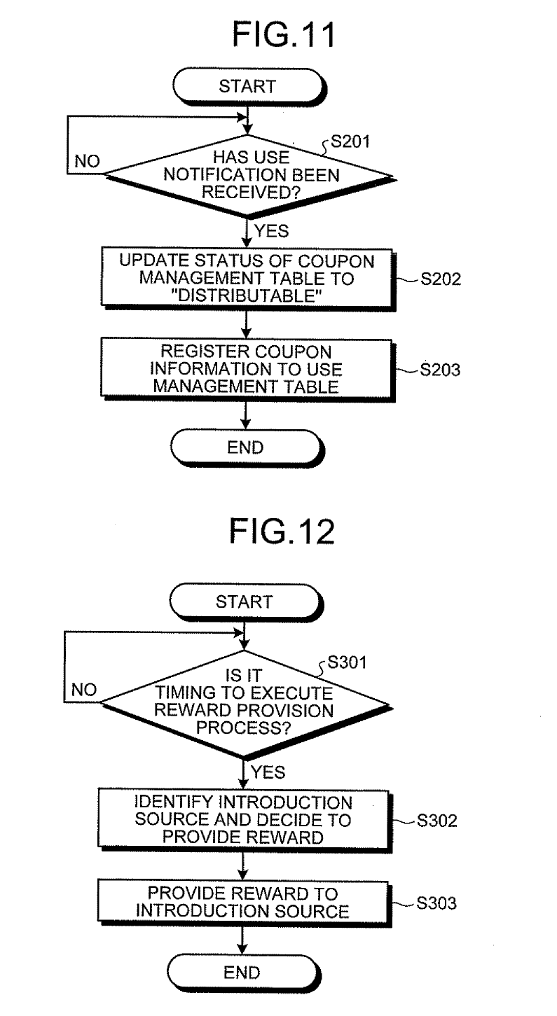

Next, the flow of a process performed when the coupon distributed by the information management device 20 is used will be described with reference to FIG. 11. FIG. 11 is a flowchart for describing the flow of a process performed when the information management device according to an embodiment receives the coupon use notification. First of all, the information management device 20 determines whether the use notification has been received (step S201), and determines whether the use notification has been received again after being on standby when the use notification has not been received (No in step S201).

Then, when the use notification has been received (Yes in step S201), the information management device 20 updates the status of the used coupon stored in the coupon management table 22 to “distributable” (step S202). Further, the information management device 20 registers information of the used coupon to the use management table 23 (step S203), and ends the process.

### 7-3. Coupon Reward Provision Process

Next, the flow of a reward provision process of providing a reward to the customer of the introduction source through the information management device 20 will be described with reference to FIG. 12. FIG. 12 is a flowchart for describing the flow of a reward provision process performed by the information management device according to an embodiment. First of all, the information management device 20 determines whether it is an execution timing to execute the reward provision process (step S301), and determines whether it is an execution timing to execute the reward provision process again after being on standby when it is not the execution timing (No in step S301).

Then, when it is an execution timing to execute the reward provision process (Yes in step S301), the information management device 20 identifies the customer of the introduction source with reference to the use management table 23, and decides to provide a reward (step S302). Thereafter, the information management device 20 provides a reward to the identified customer (step S303), and ends the process.

### 8. Modification

The information management system 1 according to the embodiment may be implemented in various kinds of forms other than the above-described embodiment. In this regard, another embodiment of the information management system 1 will be described below.

### 8-1. Coupon

The above description has been made in connection with the example in which the information management system 1 according to the embodiment distributes a coupon which can be used in a store introduced by the customer A. However, an embodiment is not limited to this example, and for example, store information such as an introduction card for introducing shops such as restaurants, gyms, hair salons, barber shops and stores of goods may be distributed. Further, the information management system 1 may manage distribution of coupons and distribution of introduction cards at the same time. In this case, for example, the information management system 1 may consolidate coupons, introduction cards, and other store information using a store information identifier identifying store information instead of the coupon ID.

### 8-2. Number Limit

The information management system 1 according to the above-described embodiment limits the number of same coupons distributable by the customer A. Here, the information management system 1 may limit the number of coupons distributable by the customer A from some kinds of coupons issued by the same store. Further, for example, the information management system 1 may limit the number of coupons distributable by the customer A from a plurality of coupons issued by stores belonging to the same group.

In order to implement this function, the determining unit 27 of the information management device 20 performs the following process. First of all, when a request notification is received, the determining unit 27 extracts the coupon ID and the user ID of the introduction source from the received request notification, and refers to a status of an entry associated with a set of the extracted coupon ID and the user ID. Then, when the referred status is “distributable”, the determining unit 27 performs the following process. First of all, the determining unit 27 acquires a coupon ID representing a coupon associated with a coupon of a distribution target using the extracted coupon ID. For example, the determining unit 27 acquires a store ID associated with the extracted coupon ID from the coupon management table 22.

Then, the determining unit 27 counts the number of entries in which the status is “under distribution” among entries associated with both the extracted user ID and the acquired store ID. Thereafter, the determining unit 27 determines to distribute a coupon when the number of counted entries is smaller than a predetermined threshold value, but not to distribute a coupon when the number of counted entries is the predetermined threshold value or more. In this case, the transmitting unit 29 notifies the customer of the introduction source of the fact that it is difficult to distribute due to a limitation of the number of relevant coupons.

In the above-described example, the determining unit 27 counts the number of coupons sharing the user ID and the store ID and limits the number of distributable coupons of the same store. However, an embodiment is not limited to this example. In other words, the determining unit 27 may count the number of distributed coupons among coupons having arbitrary relevance with a coupon related to the distribution request, and determine that distribution of the coupon related to the distribution request is not performed when the number of counted coupons is a predetermined threshold value or more.

Through the above-described process, the information management system 1 can prevent an unnecessary spreading by not only limiting the number of distributable coupons having the same content but also limiting the number of distributable coupons having arbitrary relevance. As a result, the information management system 1 can increase a value of a coupon to be distributed.

### 8-3. Redistribution of Coupon

The above embodiment has been described in connection with the example in which the information management system 1 allows the customer A to redistribute a coupon when the coupon is distributed from the customer A to the customer B and then the coupon is used by the customer B. However, the information management system 1 may approve redistribution of a coupon by the customer B.

For example, when a coupon is distributed from the customer A to the customer B, the information management system 1 stops distribution of the same coupon by the customer A. However, the information management system 1 allows redistribution of a coupon from the customer B to the customer C, redistribution from the customer C to a customer D, and the like. Then, when a customer who finally receives a coupon uses a store, the information management system 1 may perform reactivation of a coupon distributable by the customer A and provision of a reward to the customer A.

In order to implement this function, for example, a user ID of a customer as a coupon distribution destination, that is, an introduction destination ID is added to each entry in the coupon management table 22 of the information management device 20. Further, when a coupon is distributed from the customer A to the customer B, the updating unit 28 extracts an entry of a coupon of a distribution target from the coupon management table 22, updates the status of the extracted entry to “under distribution”, and stores the user ID of the customer B serving as the coupon distribution destination as the introduction destination ID.

Further, when the customer B redistributes the coupon to the customer C, the information management device 20 receives a redistribution request including the coupon ID of the coupon to be redistributed from the terminal device 10a of the customer B or the message delivery server 40. Here, the redistribution request includes the user ID of the customer B serving as the introduction source ID and the user ID of the customer C serving as the introduction destination ID.

In this case, the determining unit 27 extracts the coupon ID and the introduction source ID included in the redistribution request, and searches for an entry associated with a set of the coupon ID and the introduction destination ID from the coupon management table 22 using the extracted introduction source ID as the introduction destination ID. For example, when the coupon ID “coupon #1” and the introduction source ID “B” are extracted from the redistribution request, the determining unit 27 searches for an entry including the coupon ID “coupon #1” and the introduction destination ID “B”.

Then, when the entry associated with the extracted coupon ID and the introduction destination ID is searched from the coupon management table 22, the determining unit 27 determines that redistribution of the coupon is allowed. Further, when it is difficult to search for the entry associated with the extracted coupon ID and the introduction destination ID from the coupon management table 22, the determining unit 27 determines that redistribution of the coupon is not allowed.

Meanwhile, when the determining unit 27 determines that redistribution of the coupon is allowed, the updating unit 28 extracts the introduction destination ID from the redistribution request, and updates the introduction destination ID of the entry detected by the determining unit 27 to the extracted ID. Further, when the determining unit 27 determines that redistribution of the coupon is allowed, the transmitting unit 29 performs a process of transmitting a URL used to download a coupon to a terminal device used by a customer of a coupon distribution destination or transmitting a coupon to the message delivery server 40. When the determining unit 27 determines that redistribution of the coupon is not allowed, the transmitting unit 29 transmits a notification representing that redistribution of a coupon is not allowed to a terminal device of a customer of a coupon distribution source or the message delivery server 40.

As described above, the information management system 1 stores the user ID of the customer serving as the coupon distribution destination. Then, when the redistribution request is received, the information management system 1 determines whether the user ID of the customer serving as the coupon redistribution source is stored as the coupon distribution destination. Thereafter, when the user ID of the customer serving as the coupon redistribution source is stored as the coupon distribution destination, the information management system 1 approves redistribution of a coupon and stores the user ID of the customer serving as the coupon redistribution destination.

Thus, the information management system 1 can approve redistribution of a coupon while maintaining unity of a coupon. For example, the information management system 1 can cause the coupon distributed from the customer A to the customer B to be redistributed from the customer B to the customer C. Further, since the coupon redistributed to the customer C cannot be distributed from the customer A and the customer B to another customer D, the information management system 1 can maintain unity of a coupon. Further, when redistribution is approved, the information management system 1 may provide a reward only to a first distribution source or may provide a reward to each of customers who redistribute.

### 8-4. Others

The information management device 20 described above includes the coupon database 24. However, an embodiment is not limited to this example. For example, the information management system 1 may access a coupon database system that stores data of various kinds of coupons via the network 2 and request the coupon database system to generate a URL used to download a coupon or transmit a coupon.

Further, the functions of the information management device 20 and the message delivery server 40 may be implemented by a plurality of server devices using a so-called cloud function. For example, the functions of the determining unit 27, the updating unit 28, the transmitting unit 29, and the reward deciding unit 30 of the information management device 20 may be implemented by different server devices, respectively. Further, the functions of the receiving unit 45, the detecting unit 46, and the transfer unit 47 of the message delivery server 40 may be implemented by different server devices, respectively. Further, the functions of the units 27 to 30 and the units 45 to 47 may be combined or separated in an arbitrary form.

Further, the above embodiment has been described in connection with the example in which the terminal devices 10 and 10a are terminals such as smart phones. However, a display processing device capable of displaying various kinds of information can be applied as the terminal devices 10 and 10a although the device is not a terminal device such as a smart phone. For example, the terminal devices 10 and 10a may be a tablet-type PC, a notebook-type personal computer (PC), a desktop personal computer (PC), or a personal digital assistant (PDA). Further, the terminal devices 10 and 10a may be a printer which can print a coupon or an introduction card and is connectable to the network 2.

In the above embodiment, among the above-described processes, all or some of the processes described as being automatically performed may be manually performed, and all or some of the processes described as being manually performed may be automatically performed by a known method. Further, a process procedure, a concrete name, and information including various kinds of data or parameters which are described in the detailed description or the drawings can be arbitrarily changed unless otherwise set forth herein.

For example, various kinds of information illustrated in the drawings are not limited to information illustrated in the drawings. Further, for example, a QR code (a registered trademark), a map or a user interface (UI) of an application which are illustrated in the drawings are not limited to the above example.

The components of the devices illustrated in the drawings are functionally conceptual and do not require to be necessarily physically configured as illustrated in the drawings. In other words, a concrete form of dispersion or integration of the devices is not limited to the example illustrated in the drawings, and all or a part thereof may be configured to be functionally or physically dispersed or integrated in arbitrary units according to various kinds of loads or use situations. Further, the function of the respective components may be implemented by executing a predetermined information management program through a central processing unit (CPU).

### 9. Advantages

As described above, the information management device 20 according to an embodiment stores the status representing whether a coupon has been distributed. Further, upon receiving the distribution request of requesting distribution of a coupon from a first customer to a second customer, the information management device 20 determines whether the coupon has been distributed with reference to the status of the coupon related to the received distribution request. Then, the information management device 20 does not distribute the coupon to the second customer when the coupon has been distributed but distributes the coupon to the second customer when the coupon has not been distributed. Further, the information management device 20 updates the status of the coupon “under distribution” when the coupon has been distributed and updates the status of the coupon to “distributable” when the distributed coupon has been used.

Thus, the information management device 20 can induce the customer serving as the coupon introduction source to deliver the coupon to the customer who is more likely to visit to the store. Further, when the coupon has been used, redistribution of the same coupon is approved, and thus the information management device 20 can generate the customer luring cycle encouraging a new customer to come to a store through distribution of a coupon. Further, since a coupon is not distributed to a large indefinite number of customers, the information management device 20 can easily adjust a value of a coupon added by a store.

Further, when the customer serving as the coupon introduction destination uses the store related to the coupon, the information management device 20 decides to provide a reward to the customer serving as the coupon introduction source. Thus, the information management device 20 can motivate the customer serving as the coupon introduction source to distribute the coupon and further strengthen the customer luring cycle by repetitive distribution of the same coupon.

Further, the information management device 20 stores a plurality of entries in which a set of the user ID and the coupon ID is associated with a status representing whether a coupon has been distributed. Then, upon receiving the distribution request, the information management device 20 determines that distribution of the coupon is not performed when the statuses of all of the entries associated with a set of the user ID of the customer who distributes the coupon and the coupon ID of the coupon to be distributed are “under distribution”. Thus, the information management device 20 can distribute a plurality of same coupons to respective customers.

Further, the information management device 20 identifies the coupon ID of the coupon related to the coupon ID of the coupon of the distribution target, and identifies the status associated with each set of the user ID of the customer serving as the coupon introduction source and the identified coupon ID. Then, the information management device 20 counts the number of statuses having the value of “under distribution” among the identified statuses. Then, the information management device 20 determines that the coupon of the distribution target has been distributed when the number of counted statuses is a predetermined threshold value or more. Thus, the information management device 20 can flexibly set a coupon distribution form. For example, the information management device 20 can limit the number of distributable coupons from a plurality of kinds of coupons which can be used at the same store or limit the number of distributable coupons from coupons of stores belonging to the same group.

Further, the information management device 20 stores the user ID of the customer serving as the coupon distribution destination. Then, when a request to distribute the coupon from the second customer, who receives the coupon from the first customer, to a third customer is made, the information management device 20 determines whether the second customer is a customer who has received the coupon with reference to the stored user ID. Then, when it is determined that the second customer is the customer who has received the coupon, the information management device 20 causes the coupon to be distributed from the second customer to the third customer. Thus, the information management device 20 can redistribute the coupon while maintaining unity of the coupon.

Further, the information management system 1 includes a plurality of terminal devices 10 and 10a, the message delivery server 40 that relays a message and the information management device 20. Here, upon receiving a message, the message delivery server 40 determines whether a coupon distribution instruction is included in the received message, and transmits the distribution request to the information management device 20 when the coupon distribution instruction is included in the received message. Thus, the information management system 1 can distribute a coupon through a messenger application.

The exemplary embodiments of the present disclosure have been described above with reference to the accompanying drawings, but the above embodiments are exemplary, and the embodiments may be implemented in the other forms in which various changes or improvements are made on the embodiments described in the detailed description based on knowledge of a person skilled in the art.

Further, “unit” set forth in the accompanying claims can be interpreted as “section, or module”, “a circuit”, or the like. For example, an acquiring unit can be interpreted as an acquiring module or an acquiring circuit.

### 10. Program

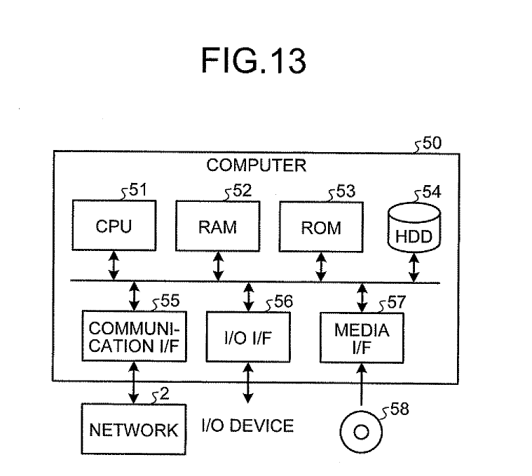

The information management device 20 according to the above embodiment is realized as, for example, a computer 50 having a configuration illustrated in FIG. 13 executes an information management program. FIG. 13 is a diagram illustrating an exemplary hardware configuration of a computer that executes an information management program. The computer 50 includes a CPU 51, a random access memory (RAM) 52, a read only memory (ROM) 53, a hard disk drive (HDD) 54, a communication interface (I/F) 55, an input/output (I/O) I/F 56 and a media I/F 57.

The CPU 51 operates based on a program stored in the ROM 53 or the HDD 54, and controls the respective components. The ROM 53 stores a boot program executed by the CPU 51 when the computer 50 is activated, a program depending on hardware of the computer 50, and the like.

The HOD 54 stores the information management program executed by the CPU 51, data used by the information management program, and the like. For example, the HDD 54 stores data such as the coupon management table 22 illustrated in FIG. 5, the use management table 23 illustrated in FIG. 6, the coupon database illustrated in FIG. 4. The communication I/F 55 receives data from another device via the network 2, transmits the data to the CPU 51 and transmits data generated by the CPU 51 to another device via the network 2.

The CPU 51 controls an output device such as a display or a printer, an input device such as a keyboard or a mouse, through the I/O I/F 56. The CPU 51 acquires data from the input device through the I/O I/F 56. Further, the CPU 51 outputs generated data to the output device through the I/O I/F 56.

The media I/F 57 reads a program or data stored in a recording medium 58, and provides the program or the data to the CPU 51 through the RAM 52. The CPU 51 loads the program from the recording medium 58 onto the RAM 52 through the media I/F 57, and executes the loaded program. Examples of the recording medium 58 include an optical recording medium such as a digital versatile disc (DVD) or a phase change rewritable disk (PD), a magneto optical recording medium such as a magneto-optical disk (MO), a tape medium, a magnetic recording medium, and a semiconductor memory.

When the computer 50 functions as the information management device 20 according to the embodiment, the CPU 51 of the computer 50 executes the program loaded onto the RAM 52 and implements the functions of the determining unit 27, the updating unit 28, the transmitting unit 29, and the reward deciding unit 30.

The CPU 51 of the computer 50 reads the information management program from the recording medium 58 and executes the information management program, but as another example, the program may be acquired from another device via the network 2.

According to an aspect of the embodiment, a coupon is distributed to new customers who are likely to visit to a store, and the customer luring cycle can be generated.

According to the invention, it is possible to relax access restriction temporarily through an easy operation under the supervision of a manager.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information management device, comprising:
a storage unit that stores distribution information representing whether shop information has been distributed;
a determining unit that determines whether the shop information has been distributed with reference to the distribution information stored in the storage unit when a distribution request for requesting distribution of the shop information from a first user to a second user is received;
a distributing unit that does not distribute the shop information to the second user when the determining unit determines that the shop information has been distributed and distributes the shop information to the second user when the determining unit determines that the shop information has not been distributed; and
an updating unit that updates the distribution information to distribution information representing that the shop information has been distributed when the distributing unit distributes the shop information to the second user, and updates the distribution information to distribution information representing that the shop information has not been distributed when the second user uses a store related to the shop information.

2. The information management device according to claim 1, further comprising,
a deciding unit that decides to provide a reward to the first user when the store related to the shop information is used by the second user.

3. The information management device according to claim 1,
wherein the storage unit stores a plurality of pieces of information in which a set of a user identifier representing a user and a shop information identifier representing shop information distributable by the user associated with distribution information representing whether the associated shop information has been distributed by the user, and
the determining unit refers, when the distribution request is received from the first user, to a plurality of pieces of distribution information associated with a set of a user identifier representing the first user and a shop information identifier of shop information serving as a distribution target among pieces of distribution information stored in the storage unit, and determines that the shop information has been distributed when all pieces of the referred distribution information represent that the shop information has been distributed.

4. The information management device according to claim 3,
wherein the determining unit counts the number of pieces of distribution information representing that the shop information has been distributed among pieces of distribution information associated with a set of a user identifier representing the first user and shop information identifier representing a shop information of a distribution target or a shop information related to the shop information of a distribution target, and determines that the shop information has been distributed when the counted number is a predetermined threshold value or more.

5. The information management device according to claim 1,
wherein the storage unit further stores user information representing a user to whom the shop information is distributed,
the determining unit determines, when a distribution request for requesting distribution of shop information from the second user to a third user is received, whether the second user is a user to whom the shop information is distributed with reference to the user information stored in the storage unit, and
the distributing unit distributes the shop information to the third user when the determining unit determines that the second user is the user to whom the shop information is distributed.

6. An information management system, comprising:
a plurality of terminal devices;
a message delivery device that relays a message; and
an information management device that manages shop information,
wherein the message delivery device includes
a first determining unit that determines whether distribution instruction of shop information is included in the message to be transmitted from a first terminal device to a second terminal device, and
a transmitting unit that transmits a distribution request for requesting distribution of the shop information from the first terminal device to the second terminal device to the information management device when the first determining unit determines that the distribution instruction of the shop information is included in the message, and
the information management device includes
a storage unit that stores distribution information representing whether the shop information has been distributed,
a second determining unit that determines whether the shop information related to the distribution request has been distributed with reference to the distribution information stored in the storage unit when the distribution request is received from the message delivery device,
a distributing unit that does not distribute the shop information to the second terminal device when the second determining unit determines that the shop information related to the distribution request has been distributed and distributes the shop information to the second terminal device when the second determining unit determines that the shop information has not been distributed; and
an updating unit that updates the distribution information to distribution information representing that the shop information has been distributed when the distributing unit distributes the shop information to the second terminal device, and updates the distribution information to distribution information representing that the shop information has not been distributed when a user of the second terminal device uses a store related to the shop information.

7. The information management system according to claim 6, the information management device further including,
a deciding unit that decides to provide a reward to the first user when the store related to the shop information is used by the second user.

8. The information management system according to claim 6, wherein
the storage unit stores a plurality of pieces of information in which a set of a user identifier representing a user and a shop information identifier representing shop information distributable by the user associated with distribution information representing whether the associated shop information has been distributed by the user, and
the second determining unit refers, when the distribution request is received from a first user, to a plurality of pieces of distribution information associated with a set of a user identifier representing the first user and a shop information identifier of shop information serving as a distribution target among pieces of distribution information stored in the storage unit, and determines that the shop information has been distributed when all pieces of the referred distribution information represent that the shop information has been distributed.

9. The information management system according to claim 8, wherein the second determining unit counts the number of pieces of distribution information representing that the shop information has been distributed among pieces of distribution information associated with a set of a user identifier representing the first user and shop information identifier representing a shop information of a distribution target or a shop information related to the shop information of a distribution target, and determines that the shop information has been distributed when the counted number is a predetermined threshold value or more.

10. The information management system according to claim 6, wherein
the storage unit further stores user information representing a user to whom the shop information is distributed,
the second determining unit determines, when a distribution request for requesting distribution of shop information from the second user to a third user is received, whether the second user is a user to whom the shop information is distributed with reference to the user information stored in the storage unit, and
the distributing unit distributes the shop information to the third user when the second determining unit determines that the second user is the user to whom the shop information is distributed.

11. An information management method performed by an information management device, the information management method comprising:
determining whether a shop information has been distributed with reference to a storage device, storing distribution information representing whether the shop information has been distributed, when a distribution request for requesting distribution of the shop information from a first user to a second user is received;
distributing includes distributing the shop information to the second user when it is determined that the shop information has not been distributed, and not distributing the shop information to the second user when it is determined that the shop information has been distributed and distributing; and
updating the distribution information stored in the storage device to distribution information representing that the shop information has been distributed when the shop information has been distributed to the second user, and updating the distribution information stored in the storage device to distribution information representing that the shop information has not been distributed when the second user uses a store related to the shop information.

12. The information management method according to claim 11, further comprising,
deciding to provide a reward to the first user when the store related to the shop information is used by the second user.

13. The information management method according to claim 11, wherein
the storage device stores a plurality of pieces of information in which a set of a user identifier representing a user and a shop information identifier representing shop information distributable by the user associated with distribution information representing whether the associated shop information has been distributed by the user, and
the determining includes referring, when the distribution request is received from the first user, to a plurality of pieces of distribution information associated with a set of a user identifier representing the first user and a shop information identifier of shop information serving as a distribution target among pieces of distribution information stored in the storage device, and determines that the shop information has been distributed when all pieces of the referred distribution information represent that the shop information has been distributed.

14. The information management method according to claim 13, wherein the determining includes counting the number of pieces of distribution information representing that the shop information has been distributed among pieces of distribution information associated with a set of a user identifier representing the first user and shop information identifier representing a shop information of a distribution target or a shop information related to the shop information of a distribution target, and determining that the shop information has been distributed when the counted number is a predetermined threshold value or more.

15. The information management method according to claim 11, wherein
the storage device further stores user information representing a user to whom the shop information is distributed,
the determining includes determining, when a distribution request for requesting distribution of shop information from the second user to a third user is received, whether the second user is a user to whom the shop information is distributed with reference to the user information stored in the storage device, and
the distributing includes distributing the shop information to the third user when the determining unit determines that the second user is the user to whom the shop information is distributed.

16. A non-transitory computer readable storage medium having stored therein an information management program causing a computer to execute a process, the process comprising:
determining whether a shop information has been distributed with reference to a storage device, storing distribution information representing whether the shop information has been distributed, when a distribution request for requesting distribution of the shop information from a first user to a second user is received;
distributing includes distributing the shop information to the second user when it is determined that the shop information has not been distributed, and not distributing the shop information to the second user when it is determined that the shop information has been distributed and distributing; and
updating the distribution information stored in the storage device to distribution information representing that the shop information has been distributed when the shop information has been distributed to the second user, and updating the distribution information stored in the storage device to distribution information representing that the shop information has not been distributed when the second user uses a store related to the shop information.

17. The non-transitory computer readable storage medium according to claim 16, the process further comprising,
deciding to provide a reward to the first user when the store related to the shop information is used by the second user.

18. The non-transitory computer readable storage medium according to claim 16, the process wherein
the storage device stores a plurality of pieces of information in which a set of a user identifier representing a user and a shop information identifier representing shop information distributable by the user associated with distribution information representing whether the associated shop information has been distributed by the user, and
the determining includes referring, when the distribution request is received from the first user, to a plurality of pieces of distribution information associated with a set of a user identifier representing the first user and a shop information identifier of shop information serving as a distribution target among pieces of distribution information stored in the storage device, and determines that the shop information has been distributed when all pieces of the referred distribution information represent that the shop information has been distributed.

19. The non-transitory computer readable storage medium according to claim 18, the process wherein the determining includes counting the number of pieces of distribution information representing that the shop information has been distributed among pieces of distribution information associated with a set of a user identifier representing the first user and shop information identifier representing a shop information of a distribution target or a shop information related to the shop information of a distribution target, and determining that the shop information has been distributed when the counted number is a predetermined threshold value or more.

20. The non-transitory computer readable storage medium according to claim 16, the process wherein
the storage device further stores user information representing a user to whom the shop information is distributed,
the determining includes determining, when a distribution request for requesting distribution of shop information from the second user to a third user is received, whether the second user is a user to whom the shop information is distributed with reference to the user information stored in the storage device, and
the distributing includes distributing the shop information to the third user when the determining unit determines that the second user is the user to whom the shop information is distributed.
